(19) United States
(12) Patent Application Publication
(10) Pub. No.: US 2018/0006733 A1
(43) Pub. Date: Jan. 4, 2018

(54) SUBSEA LONG-HAUL TRANSPONDER

(71) Applicant: David Ross Group, Morristown, NJ (US)

(72) Inventors: Gerald Tourgee, Cambridge, MA (US); John J. Mariano, Randolph, NJ (US); Gerald S. Soloway, New York, NY (US)

(21) Appl. No.: 15/168,914

(22) Filed: May 31, 2016

(51) Int. Cl. H04B 10/80; H04B 10/40; G01V 1/18; H04J 14/04; G01S 1/72

(52) U.S. Cl. CPC H04B 10/801; H04J 14/04; G01S 1/72; G01V 1/18; H04B 10/40

(57) ABSTRACT

A subsea optical communication network includes branch systems whereby transponders may be connected to trunk fibers carrying data to and from the transponders, e.g., to and from shore. Trunk nodes split transponder receive signals off the trunk and couple transponder transmit signals onto the trunk. Each trunk node also removes a wavelength/channel from the trunk signal to compensate for the wavelength being added with transponder data. Removed wavelengths may be selected from idler wavelengths, e.g., empty channels or noise, or previously dropped transponder wavelengths. Branch signals may be single wavelength in either direction, allowing the use of low-bandwidth repeaters, and the same wavelength may be used in both directions. Branch signals may alternatively contain plural wavelengths that load a standard wide-bandwidth commercial repeater, where an optical add drop multiplexer is used to select the wavelength of interest to the transponder after the repeater.

### GOVERNMENT RIGHTS

This invention was made with government support under contract number N00024-15-C-401 awarded by the U.S. Naval Sea System Command. The government has certain rights in the invention.

### FIELD OF INVENTION

This patent relates to the field of submarine fiber-optic cable systems.

### BACKGROUND

Submarine communication cable systems can take many forms. One basic topology is a point to point system which originates on one shore, traverses a body of water, and terminates on another shore. Topologies may also include many segments and branches. FIG. 1 shows a hypothetical example trans-Pacific cable system 100. The system 100 connects a shore terminus 112 in Japan to a shore terminus 110 on the west coast of the United States. The cable segments 120, 122, and 124 form a trunk. Segment 126, which connects to the trunk at branching unit 102, forms a branch to an additional landing in Guam 104. Segment 128, which connects to the trunk at branching unit 106, forms a branch to a landing in Hawaii 108.

Some submarine communication cable systems have only one shore terminus. For example, a cable system with a single terminus may be used to collect data from sensors laid on the bottom of the ocean, rather than to carry communications across a body of water. Such sensors may take, for example, environmental measurements such as temperature, pressure or seismic data, or collect underwater sonar data which can be used to detect shipping or whale migrations. Examples of such systems include the Dense Oceanfloor Network system for Earthquakes and Tsunamis (DONET) deployed off the cost of Japan, and the sound surveillance system SOSUS deployed in the northern Atlantic.

Typically, the sensors in such systems communicate at low speeds. Sensor communication may be continuous, periodic, or occasional. Communication may be bidirectional or, alternatively, sensor communication may be in one direction only, i.e., where data is sent from the sensor to shore but there is no communication from shore to the sensor.

FIG. 2 is a schematic of a portion of an undersea fiber-optic cable system 200 which provides bidirectional communication with sensor devices. System 200 has a single terminus 202. A trunk line has segments 220-230 running from a shore terminus 202 to trunk nodes 204 and 214 and beyond. The trunk line may be several thousands of kilometers long. For distances longer than 500 km, repeaters may be needed to amplify the optical signals. In sensor systems, branch systems are typically shorter than 500 km, but may be perhaps several hundred kilometers in length, or longer, where repeaters may be required. In the example of FIG. 2, signal along the trunk line is boosted by periodically placed repeaters 208.

A single wavelength may be used both to drop data from the shore to the sensor node, and to transmit data from the sensor node to shore. A first branch segment 232 connects trunk node 204 to a sensor node 206. Branch segment 232 carries a first wavelength λ1 to and from the sensor node 206 on two separate fibers. A second branch segment 234 connects trunk node 214 to a sensor node 216. Branch segment 234 carries a second wavelength λ2 to and from the sensor node 216. The trunk carries both wavelengths λ1 and λ2, and potentially many others.

### SUMMARY

A subsea optical communication network includes branch systems whereby transponders may be connected to a pair of trunk fibers carrying data to and from the transponders, e.g., to and from each other or shore. Trunk nodes split transponder receive signals off the trunk and couple transponder transmit signals onto the trunk. Each trunk node also removes a wavelength/channel from the trunk signal to compensate for the wavelength being added with transponder data. Removed wavelengths may be selected from idler wavelengths, e.g., empty channels or noise, or previously dropped transponder wavelengths. Branch signals may be single wavelength in either direction, allowing the use of low-bandwidth repeaters, and the same wavelength may be used in both directions, e.g., on both fibers of the fiber pair. Branch signals may alternatively contain plural wavelengths that load a standard wide-bandwidth commercial repeater, where an optical add drop multiplexer is used to select the wavelength of interest to the transponder after the repeater.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

A more detailed understanding may be had from the following description, given by way of example in conjunction with the accompanying figures. The figures are not necessarily drawn to scale.

FIG. 1 is a schematic view of a hypothetical prior art trans-pacific undersea communications cable system.

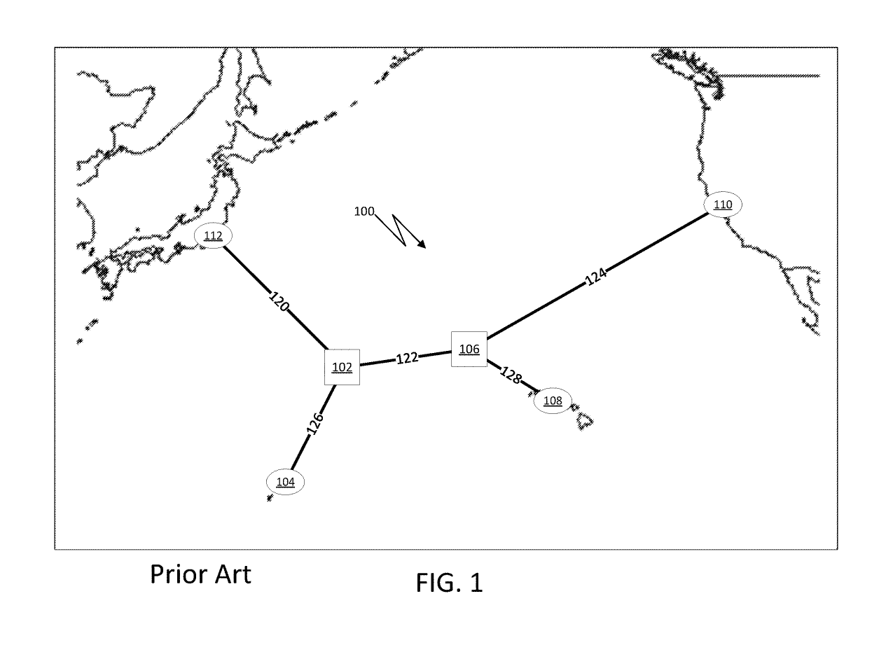

FIG. 2 is a schematic view of a hypothetical prior art of a portion of an undersea cable communication system for sensors, where the system has a single terminus.

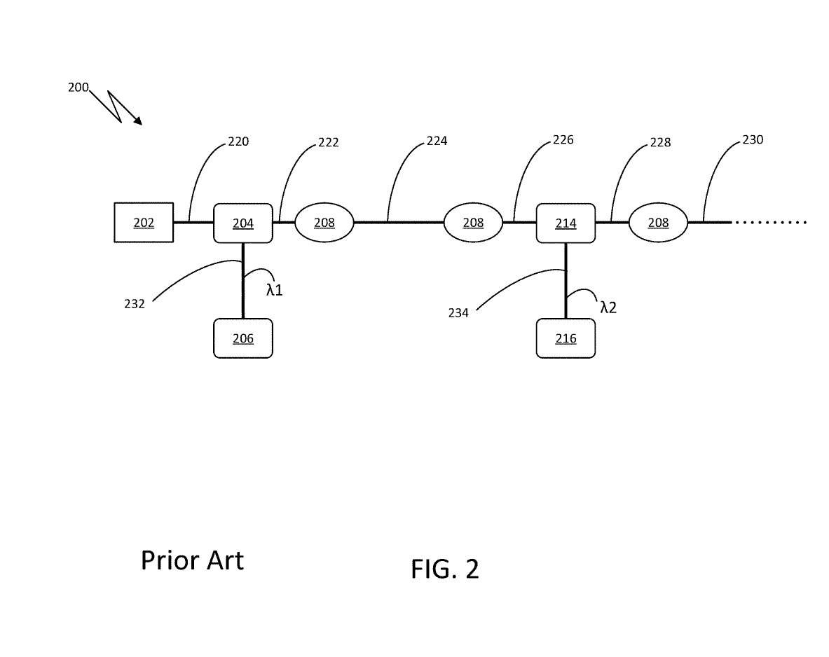

FIG. 3 is a schematic of an example of a transoceanic undersea cable communication system for transponders, where the system has a western terminus and an eastern terminus.

FIG. 4 shows a scheme for the management of wavelengths in the undersea cable communication system of FIG. 3, where idler wavelengths are eliminated as transponder wavelengths are added.

FIG. 5 shows a scheme for the management of wavelengths in the undersea cable communication system of FIG. 3, where old transponder wavelengths are eliminated as new transponder wavelengths are added.

FIG. 6 is a schematic of an example transponder branch using standard commercial multi-channel repeaters with an OADM and coupler associated with the transponder node.

FIG. 7 is a schematic of an example system with a single shore terminus with a single trunk fiber looped back on itself.

### DETAILED DESCRIPTION

A subsea optical communication network includes branch systems whereby transponders may be connected to trunk fibers carrying data to and from the transponders, e.g., to and from each other or shore. Trunk nodes split transponder receive signals off the trunk and couple transponder transmit signals onto the trunk. Each trunk node also removes a wavelength/channel from the trunk signal to compensate for the wavelength being added with transponder data. Herein the terms, “lambda,” “wavelength,” “channel,” may be used interchangeably to refer to an optical data carrier frequency with or without attendant modulated data information.

Removed wavelengths may be selected from idler wavelengths, e.g., empty channels or noise, or previously dropped transponder wavelengths. Optionally, the removed wavelength may be same as the wavelength carrying the transmission from the transponder.

Branch signals may be a single wavelength in either direction, allowing the use of low-bandwidth repeaters such as a single channel erbium-doped fiber amplifier (EDFA) amplifier, and the same wavelength may be used in both directions. For example, a trunk node may filter the signal split off from a trunk fiber and transmit only a single wavelength to the transponder via a branch fiber. Similarly, the transponder may send only a single wavelength back to the trunk. This allows the use of low-bandwidth repeaters, and even single-channel repeaters along the branch. Such repeaters use less power than standard commercial repeaters, which may require a minimum of six wavelengths for proper loading.

The transponder may optionally use the same wavelength to send and receive data, for example, e.g. when using a coherent transceiver, where a single laser is used both for receiving and transmitting data, saving parts and power.

Branch signals may alternatively contain plural wavelengths that load a standard wide-bandwidth commercial repeater, where an optical add drop multiplexer (OADM) is used to select the wavelength of interest to the transponder after the repeater. The optical add drop multiplexer may also feed other frequencies to a coupler connected to the transponder transmitter, in order to properly load the multi-channel repeater on the path back to the trunk.

Herein, the terms “transponder” and “transponder device” may be used interchangeably to refer to any underwater apparatus including a transmitter and a receiver.

Transponders may be used, for example, to collect data from, and transmit data to, devices including the following: sensors such as seismic and sonar sensors; other scientific instruments; docking stations for divers, underwater vehicles or automatons; geothermal, mining, drilling, or pumping devices; and other scientific, industrial, or military equipment.

Subsea optical communication networks that include such branch systems may take a variety of forms, such as a shore to shore system with a terminus on each of two shores, or a star pattern with multiple landings and terminus sites. Similarly, such networks may have a single terminus. For example, a single optical fiber may be looped back onto itself to form a trunk cable, where the fiber is used both for outbound communications and, after turning back to shore, for inbound communications as well.

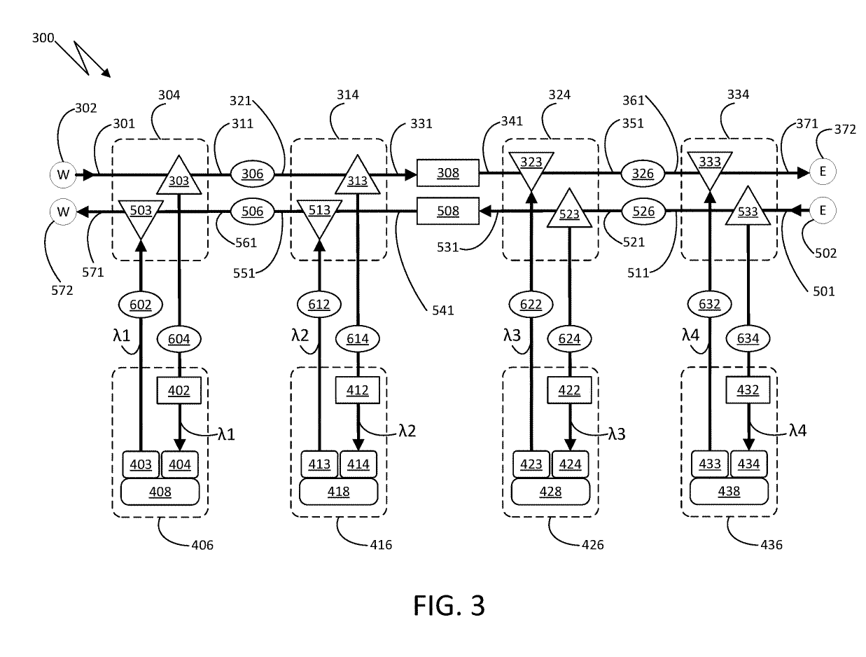

FIG. 3 is a schematic of a submarine fiber-optic cable system 300 that allows a single channel to be dropped from the cable and/or added to the cable along its route at various locations. Herein the term “drop” refers to diverting a portion of a trunk signal to a destination where the data is consumed. The term “drop” does not mean that the portion of the signal is removed from the trunk signal. Herein the terms “remove” or “eliminate” refer to taking a portion of a signal, e.g., a carrier wavelength or a band or sub-band of adjacent carrier wavelengths, out of the trunk signal such that the signal does not propagate past the point of removal.

System 300 is shown as including one trunk line and four transponder branches. In practice, such a system may contain a number of interconnected trunk lines, as well as any number of transponder branches coupled to one or more trunk lines. Not shown in FIG. 3 per se, data may be transmitted from one sensor node to another sensor or a recording or analytic device, and not to shore.

System 300 includes a trunk fiber pair extending from a western shore terminus, at points 302 and 572, to an eastern shore terminus, at points 372 and 502. The upper trunk fiber, made up of segments 301, 311, 321, 331, 341, 351, 361, and 371 transmits from left to right. The lower trunk fiber, made up of segments 501, 511, 521, 551, 541, 551, 561, and 571, transmits from right to left. Trunk repeaters 306, 326, 506, and 526 are positioned periodically along the trunk fibers. Between the eastern and western portions of the trunk fibers are band selection filters, 308 and 508, which may be band rejection filters. Band selection filters 308 and 508 may be used such that the band or sub-band, where signals will be added, will be free of noise that has accumulated along the trunk until that point.

Transponder nodes 406, 416, 426, and 436 are connected to the trunk fiber pair via trunk nodes 304, 314, 324, and 334, respectively. Trunk nodes 304, 314, 324, and 334 serve as branching units. Trunk nodes 304, 314, 324, and 334 include splitters 303, 313, and 523, and 533, respectively, which divert a portion of the signal travelling along the trunk to their respective transponder node 406, 416, 426, and 436. Splitters 303, 313, and 523, and 533 may include or be followed by band selection units, such as band pass filters, which pass only a single wavelength, λ1-λ4, respectively, to their respective transponder node 406, 416, 426, and 436. Splitters 303, 313, and 523, and 533 may also be followed by signal boosting amplifiers.

Trunk nodes 304, 314, 324, and 334 include couplers 503, 513, 323, and 333, respectively. Couplers 503, 513, 323, and 333 may include band selection units, such as band pass filters, which pass only a single wavelength, λ1-λ4, respectively, from their respective transponder node 406, 416, 426, and 436, and or signal boosting amplifiers. Couplers 503, 513, 323, and 333 add to the trunk line the single wavelength, λ1-λ4, respectively, from their respective transponder nodes 406, 416, 426, and 436.

Couplers 503, 513, 323, and 333 may additionally include band selection units, such as band pass filters or band rejection filters to remove one or more wavelengths travelling along the trunk. This function of the couplers 503, 513, 323, and 333 may be termed a “block idler” function, since the wavelength blocked may have been an idle wavelength, e.g., carrying no valuable data, that was included in the trunk signal for purposes of balancing the load on the trunk repeaters 306, 326, 506, and 526.

Transponder nodes 406, 416, 426, and 436 include transponder devices 408, 418, 428, and 438, respectively. Transponder nodes 406, 416, 426, and 436 also include receivers 404, 414, 424, and 434, respectively, which allow the transponder devices 408, 418, 428, and 438 to receive data from shore. Transponder nodes 406, 416, 426, and 436 further include transmitters 403, 413, 423, and 433 respectively, which allows each transponder devices 408, 418, 428, and 438 to send data to a shore.

Further, the transponder nodes 406, 416, 426, and 436 are shown as including band selection filters 402, 412, 422, and 432, respectively, which may be band pass filters tuned to λ1-λ4 that are used, e.g., to filter out repeater amplifier noise, or to boost signal.

In the example of FIG. 3, the sensor branches are shown as including branch repeaters 602, 604, 612, 614, 622, 624, 632, and 634. This may be broadband, narrowband, or even single wavelength devices.

As shown in FIG. 3, the same wavelength λ1-λ4 may be used in each of transponder nodes 406, 416, 426, and 436, respectively, for both sensor transmit and receive, allowing simplified transceiver design, saving parts and powers. For example, in a coherent transceiver, only a single laser may be required.

An outbound signal originates at western shore terminus point 302 and propagates along segment 301 to trunk node 304. The outbound signal may include many carrier wavelengths, including wavelengths λ1-λ2 carrying data meant for transponder nodes 406 and 416 respectively. At trunk node 304, a portion of the signal is diverted to the branch to transponder node 406 by splitter 303. Assuming that splitter 303 is a 50/50 splitter, the signal sent down the branch leg and the signal continuing along trunk segment 311 are each approximately 50% of the signal received trunk node 304, a reduction of 3 dB. Other splitter ratios may be used. After each repeater, the signal is restored to full strength, such that the signal on segment 321 is approximately equal to the signal on segment 301. The use of splitters, and the ratio of the splitters used, will affect the selection and placement of the trunk repeaters 306, 326, 506, and 526, as well as the selection and placement of branch repeaters 602, 604, 612, 614, 622, 624, 632, and 634.

Splitters 303, 313, and 523, and 533 may include band selection units, such as band pass filters, which pass only a single wavelength, λ1-λ4, respectively, to their respective transponder nodes 406, 416, 426, and 436, allowing the use of single wavelength repeaters for branch repeaters 604, 614, 624, and 634.

After repeater 306, the signal continues along trunk segment 321 to trunk node 314 where splitter 313 sends a portion of the signal down the branch leg to transponder node 416. After splitter 314, the signal continues, at diminished strength, along trunk segment 331 to an optional band selection filter 308. The signal on trunk segment 331 may contain all of the original wavelengths that originated at western shore terminus point 302. Band select filter 308 may be a band reject filter which will remove any noise signal in a so-far unused band or sub-band which will be used on the eastern half of the trunk to add wavelengths.

The eastbound signal continues along trunk segment 341 to trunk node 324. Coupler 323 adds to the trunk signal of the wavelength λ3 signal that arrives from transponder node 426. Since the addition of a new wavelength from each transponder node would impact repeater loading, it is necessary to eliminate the same amount of power from the incoming stream before each coupler. This may be done by a block idler function of each of the couplers 323, 333, 503, and 513. An “idler” can be, for example, a distinct carrier wavelength that contains no data or unneeded data. An idler may also just be a spectrum segment containing broadband noise. An idler extraction filter in each coupler 323, 333, 503, and 513 is designed to reduce the power traveling along the trunk to compensate for the addition of each sensor output wavelength. This maintains the repeater loading constant across the entire trunk cable. To facilitate this, several idler wavelengths may be included in the signal originating at western shore terminus point 302. In addition to adding wavelength λ3 to the trunk signal, the coupler 323 removes an idler wavelength or an equivalent amount of noise power from the trunk signal, such that the total optical power across the band is maintained constant or nearly constant.

After coupler 323, the eastbound signal, including the λ3 component from transponder node 426, continues along trunk segment 351 to repeater 326, and then continues on via trunk segment 361 to trunk node 334. At trunk node 334, coupler 333 similarly blocks a wavelength, e.g., an idler wavelength, arriving on segment 361 and then adds the wavelength λ4 signal from transponder node 436 to the signal travelling along trunk segment 371. This signal then arrives at eastern shore terminus point 372.

Operation of the equipment for signal travelling westbound along the lower trunk fiber mirrors that of the eastbound operations. An outbound signal originates at eastern shore terminus point 502 and propagates along segment 501 to trunk node 334. Again, the outbound signal may include many carrier wavelengths, including wavelengths λ1-λ4 among others. Wavelengths λ3 and λ4 may carry data meant for transponder nodes 426 and 436 respectively. At trunk node 334, a portion of the signal is diverted down the branch leg to transponder node 436 by splitter 533. At repeater 526, the signal is restored to full strength, and then continues along trunk segment 521 to trunk node 324 where splitter 523 sends a portion of the signal down the branch leg to transponder node 426. After splitter 523, the signal continues, at diminished strength, along trunk segment 531 to an optional band selection filter 508. The signal on trunk segment 531 may contain all of the original wavelengths that originated at eastern shore terminus point 502.

Band select filter 508 may be a band reject filter which removes noise in a so-far-unused band or sub-band.

The westbound signal continues along trunk segment 541 to trunk node 314 where coupler 513 blocks an idler wavelength arriving at coupler 513 along the trunk fiber. Coupler 513 also adds the wavelength λ2 signal arriving from transponder node 416 to the trunk signal.

After coupler 513, the westbound signal, including the λ2 component from transponder node 416, continues along trunk segment 551 to repeater 506, and then continues on via trunk segment 561 to trunk node 304. At trunk node 304, coupler 503 similarly blocks an idler wavelength arriving on segment 561. Coupler 503 adds the wavelength λ1 signal from transponder node 406 to the signal travelling along trunk segment 571. This trunk signal then arrives at western shore terminus point 572.

In the example of FIG. 3, each transponder communicates with the nearest shore, which may simplify transmission considerably. Alternatively, using this topology, signals may originate and terminate at either shore by, e.g., by altering which trunk fibers are connected to which trunk node component.

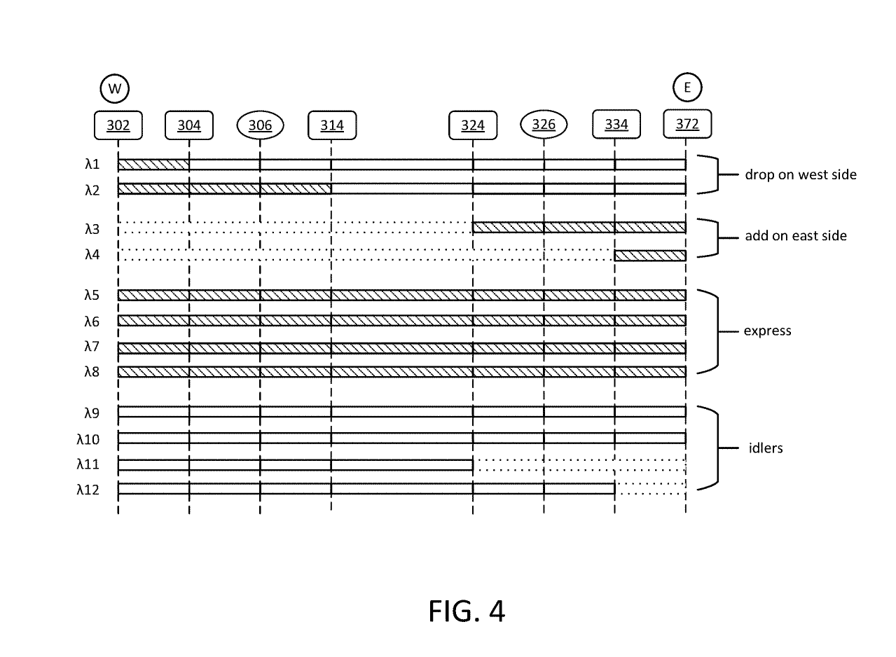

FIG. 4 depicts an example of the management of wavelengths included in the signal along the eastbound fiber of FIG. 3. The wavelengths shown in FIG. 4 are divided into four distinct sub-bands. The sub-bands may be within a single band, e.g., the C band of wavelengths ranging from 1.53 to 1.57 μm. The sub-bands may also be distributed among two or more of the O, E, S, C, L and U bands, for example. Sub-bands within a single band may be separated by guard bands, e.g., unused frequency ranges.

The signal originating at the western shore terminus point 302, include six wavelengths which bear data intended for an eastward drop point, indicated by cross-hatched boxes. Wavelengths λ1 and λ2 bear data intended for delivery to transponder devices. These are labeled as “drop-on-west-end” sub-band wavelengths. Wavelengths λ5-8 in the “express” sub-band carry data traffic bound for the eastern shore terminus point 372. Wavelengths λ3 and λ4, in the “add-on-east-end” sub-band, are not included in the original signal, as indicated by the dotted boxes. The signal originating at western shore terminus point 302 also includes four wavelengths λ9-12 in an “idler” sub-band. The idler wavelengths bear a carrier but no significant data, as indicated by boxes without cross hatches.

Following FIG. 4 from left to right, when the signal reaches trunk node 304, wavelength λ1 is dropped to a transponder node. The wavelength λ1 continues on the trunk, but the data it contains is not of interest to other devices toward the east.

When the signal reaches repeater 306, it still contains eight wavelengths. Commercial repeaters often require a certain number or range of numbers of wavelengths to be present to function properly. In the example of FIG. 4, the repeaters 306 and 326 function best when loaded with several wavelengths.

When the signal reaches trunk node 314, wavelength λ2 is dropped to a transponder node. The wavelength λ2 also continues on the trunk but, as with wavelength λ1, the data wavelength λ2 contains is not of interest to other devices toward the east.

Trunk node 324 adds wavelength λ3 to the trunk signal. However, if each coupler adds a new wavelength, and there are many couplers, the repeaters may be amplifying an increasing number of wavelengths, which is undesirable. Therefore each trunk node coupler also removes one wavelength. In the example of FIG. 4, trunk node 324 removes idler wavelength λ11 from the trunk signal, such that when the trunk signal reaches repeater 326, the trunk signal again contains eight wavelengths, albeit not the eight wavelengths originally included at western shore terminus point 302.

Similarly, when the trunk signal reaches trunk node 334, the coupler in trunk node 334 removes idler wavelength λ12 and adds transponder wavelength λ4. The number of wavelengths arriving at eastern shore terminus point 372 is the same as the number leaving western shore terminus point 302. However, it is not the same set of specific frequencies.

The scheme described in connection with FIG. 4 may be mirrored for use on the westbound fiber of FIG. 3.

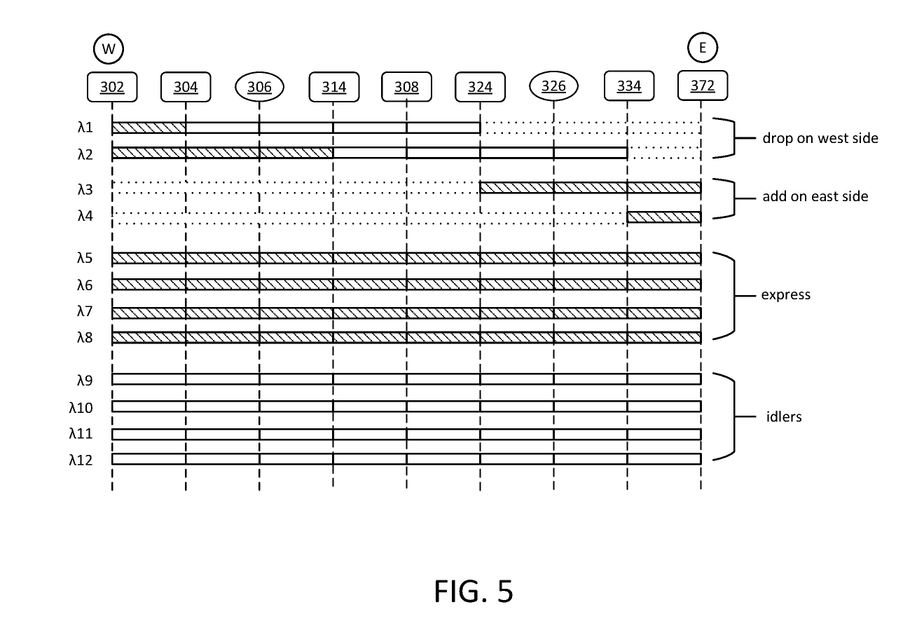

FIG. 5 is another example of the management of the wavelengths included in the signal along the eastbound fiber of FIG. 3. Here in FIG. 5, band selection filter 308 is installed. The operations at western shore terminus 302, trunk node 304, repeater 306, and trunk node 314 are as described in connection with FIG. 4. Here in FIG. 5, when the trunk signal reaches band selection filter 308, a number of wavelengths may be removed from the trunk signal at one time. In the example of FIG. 5, the “add-on-east-end” wavelengths λ3 and λ4 are removed by band selection filter 308. Wavelengths λ3 and λ4, in the example of FIG. 5, contain neither a carrier nor data signal when they arrive at band selection filter 308, but may have accumulated noise such as crosstalk since leaving western shore terminus point 302. Band selection filter 308 removes noise from these so-far unused wavelengths, allowing couplers to add signals at points on the eastern side of the system to a frequency band which is relatively free of noise, to the right of filter 308.

Trunk node 324 adds wavelength λ3 to the trunk signal. To compensate, trunk node 324 removes the drop-on-west side wavelength λ1 from the trunk signal, such that when the trunk signal reaches repeater 326, the trunk signal again contains eight wavelengths, albeit not the eight wavelengths originally included at western shore terminus point 302. Similarly, trunk node 334 adds wavelength λ4 to the trunk signal. To compensate, trunk node 324 removes the drop-on-west side wavelength λ2 from the trunk signal, such that when the trunk signal reaches eastern shore terminus point 372, the trunk signal again contains eight wavelengths, albeit not the eight wavelengths originally included at western shore terminus point 302.

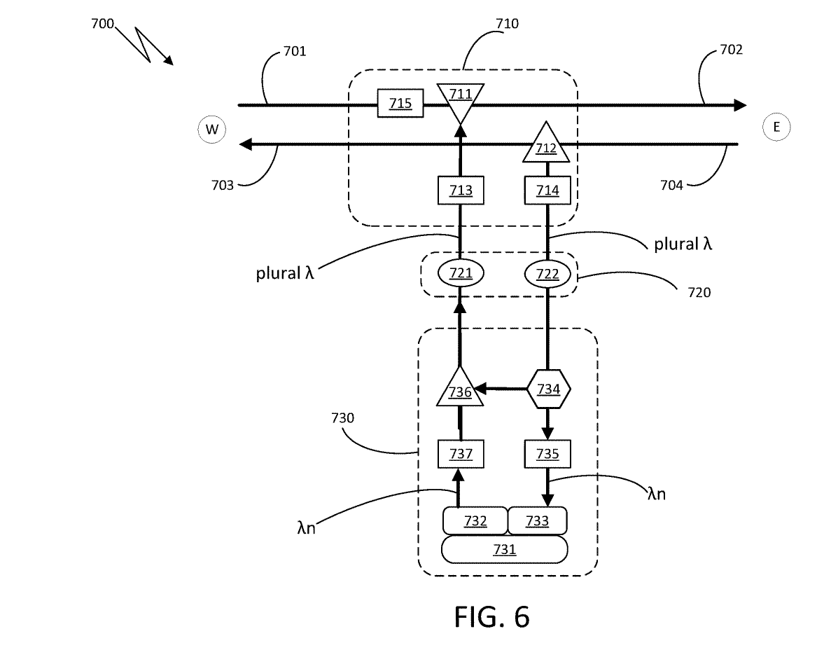

FIG. 6 shows an alternative branch system 700 that may be used in a subsea communication of the kind described in reference to FIGS. 3, 4, and 5. Branch 700 connects a transponder to a segment of a subsea long haul cable comprising two fibers. Branch 700 is shown as connecting to a trunk running from east to west. One trunk fiber, carrying data from west to east, has segments 701 and 702. The second trunk fiber, running data from east to west, has segments 703 and 704. A trunk node 710 connects a transponder node 730 via a fiber pair via a standard commercial repeater 720. In practice, multiple repeaters may be used, depending on the branch length. Trunk node 710 uses a splitter 712 to drop a portion of the trunk signal down to the transponder node 730. Unlike the trunk nodes of FIG. 3, which may filter out wavelengths that are not of interest to the respective transponder node, trunk node 710 sends all or several wavelengths of the trunk signal to the transponder node. The signal may be boosted by an optional amplifier 714. In practice, the optional amplifier may be unnecessary due to the use of repeaters.

The repeater 720 has a separate uplink repeating amplifier 721 and downlink 722 repeating amplifier. Both the uplink 721 and the downlink 722 repeating amplifiers may transmit all frequencies in the trunk signal. Alternatively, only a few wavelengths may be sent up and down the branch. Commercial repeaters generally must be loaded with several wavelengths to function properly. In practice, the branch node may have any number of such receivers along its length.

Transponder node 730 includes a transponder device 731 and a transceiver made up of receiver 733 and transmitter 732. If the transceiver is of the coherent type, the transmitter 732 and receiver 733 may use the same laser and operate at wavelength λn.

An optical add drop multiplexer (OADM) 734 selects, from the downlink signal, the single wavelength that carries the input to the transponder device 731, which is wavelength λn. All or some of the other wavelengths received by the OADM 734 are transmitted to a transponder node coupler 736. Another input of the transponder node coupler 736 is connected to the output from the transmitter 732.

Optionally, to ensure that there is no degradation of the transmit signal, in selecting wavelengths to pass to the transponder node coupler 736, it may be desirable for the OADM 734 to remove multiple wavelengths near the transponder wavelength λn, or even an entire band containing several carrier wavelengths, while still leaving enough wavelengths traversing the repeater 720 to keep the repeater 720 properly loaded. It is possible that, as a result, the number of wavelengths heading down toward the transponder node 730 will be greater than the number of channels heading back up toward the trunk node 710, but this should be able to be accommodated by the design of the repeater 720.

Alternatively, the OADM 734 and coupler 736 may be installed in the last repeater along the branch before the transponder node 730, or in a separate unit installed between the transponder node 730 and the last repeater before the transponder node 730.

Optionally, transponder node 730 may include an input booster and/or filter 735. Similarly, transponder node 730 may include an output booster and/or filter 737.

The signal returning to the trunk node 710 may be filtered by a band select filter 713, which may be a band pass filter, to select wavelength λn. To balance the load on trunk repeaters, not shown, the trunk node may remove a wavelength from the trunk signal via a band selection filter 715, which may be a notch filter for example, to compensate for the addition of the wavelength λn to the trunk signal by coupler 711.

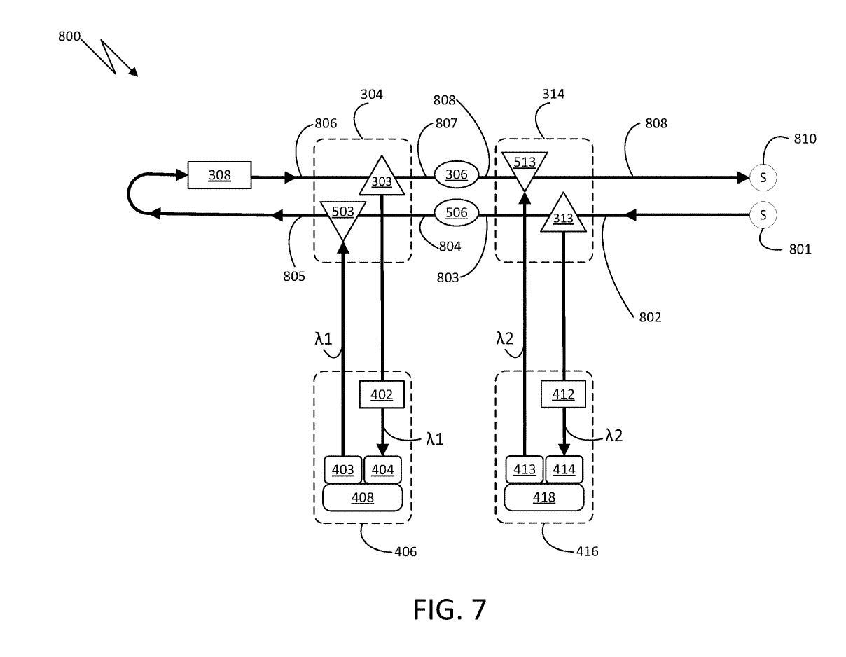

FIG. 7 shows an alternative arrangement for an undersea cable system. System 800 is illustrated as using some of the equipment described in reference to FIG. 3. The system 800 includes a trunk cable made of a single optical fiber looped back on itself, having segments 802-809. The trunk cable is connected to a single shore terminus having a transmission point 801 and a receiving point 810. In practice, such a system may have any number of transponder branches and repeaters. In the example of FIG. 8, the system is shown with two transponder branches. The operation of trunk nodes 304 and 314, repeaters 306 and 506, and transponder nodes 406 and 416 are as described in reference to FIG. 3. The band reject filter 308 may be placed, e.g., near the turnaround point of the trunk cable, to clear out wavelengths for use by trunk nodes such as trunk node 314 to add transponder signal as the fiber returns to shore. The band reject filter 308 creates a band free of noise or signal.

The system 800 may use, for example, any of the wavelength management schemes discussed in reference to FIGS. 4 and 5. For example, the band reject filter may eliminate all of the wavelengths dropped along the outbound segments of the cable 802-805. In the example of FIG. 7, this includes λ2. In practice, any number of wavelengths dropped on the outbound leg could be eliminated by the band reject filter 308 and reused by trunk nodes to add transponder signals to the inbound leg. Alternatively, if different lambdas are added and dropped, then the filter may just clean out the “add” sub-band.

In the example of FIG. 7, there may be more wavelengths traveling on the outbound segments 802-805 than on, e.g., inbound segments 806-808. The repeaters 306 and 506 should be designed such that proper launch power can be maintained in each direction. For example, if repeaters 306 and 506 are co-located, it may be possible to split the pump power such that the launch powers in each direction are the same, even though repeater 306 and repeater 506 have different individual output power. For example, if the launch power per channel was 0 dbm, then if repeater 506 carries 40 wavelengths, total launch for repeater 506 power would be 16 dbm. If repeater 306 carries only 20 wavelengths, its output power would be 13 dbm. Each repeater, or a single unit that includes both repeaters, would be designed to accommodate these different launch powers.

In describing embodiments of the subject matter of the present disclosure, as illustrated in the figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A branch system connecting a transponder to a subsea optical communication trunk cable carrying data outbound from a terminus and inbound data to the terminus, the branch system comprising a trunk node connected via a branch cable to a transponder node, where:
a. the trunk node comprises a trunk splitter coupled to an outbound fiber of the trunk cable, the trunk splitter diverting a portion of a multi-channel signal traveling on the outbound fiber to the transponder node via a receive fiber in the branch cable;
b. the trunk node further comprises a trunk coupler coupled to an inbound fiber of the trunk cable, the trunk coupler combining a multi-channel signal traveling along an inbound fiber of the trunk cable with a transponder signal at a first wavelength, where the first wavelength is received via a transmit fiber in the branch cable;
c. the trunk node further comprises a trunk filter, the trunk filter removing a second wavelength from the multi-channel signal traveling along the inbound fiber of the trunk cable;
d. where the first wavelength is selected from a first sub-band and the second wavelength from a second sub-band, where the first sub-band is separate from the second sub-band; and
e. where the transponder node comprises a transceiver, the transceiver comprising a receiver connected to the receive fiber and a transmitter connected to the transmit fiber.

2. The branch system of claim 1, wherein the second sub-band comprises idler wavelengths.

3. The branch system of claim 1, wherein the second sub-band comprises wavelengths previously dropped at other branches.

4. The branch system of claim 1, wherein the number of wavelengths transmitted by the branch system on the inbound fiber of the trunk cable is equal to the number of wavelengths received by the branch system on the outbound fiber of the trunk cable.

5. The branch system of claim 1, wherein the transceiver is a single channel transceiver, such that the transponder receives data on the first wavelength and transmits data on the first wavelength.

6. The branch system of claim 1, further comprising a bidirectional repeater connected between the trunk node and the transponder node along the branch cable, the repeater being capable of supporting fewer than six wavelengths.

7. The branch system of claim 1, further comprising a bidirectional repeater connected between the trunk node and the transponder node along the branch cable, the repeater being capable of supporting only one channel.

8. The branch system of claim 1, wherein the transponder node comprises a seismic or sonar sensor.

9. The branch system of claim 1, wherein the transponder node comprises a data dock for a diver or underwater vehicle.

10. The branch system of claim 1, further comprising:
a. a bidirectional repeater connected between the trunk node and the transponder node along the branch cable, the repeater being capable of supporting more than five wavelengths;
b. a transponder coupler connected between the transmitter and the repeater;
c. an optical add drop multiplexer connected between the repeater and the receiver;
d. where the optical add drop multiplexer selects the first wavelength for transmission to the receiver; and
e. where the optical add drop multiplexer selects other wavelengths for transmission to the coupler.

11. The branch system of claim 1, further comprising a band reject filter coupled to a trunk fiber, where the band reject filter removes plural wavelengths in the first sub-band.

12. An undersea long haul transponder system comprising plural branch systems of claim 1.

13. The transponder system of claim 12, comprising twenty or more branch systems of claim 1, where each of the branch system operates within either in the C band or in the L band.

14. The transponder system of claim 12, wherein the trunk cable extends from a first terminus on a first shore, across a body of water, to a second terminus on a second shore.

15. The transponder system of claim 14, wherein each branch system transmits toward the nearest shore.

16. The transponder system of claim 12, wherein:
a. the trunk cable extends from a first end at a first terminus on a first shore across a body of water to a second end at a point underwater,
b. where at the second end of the trunk the inbound fiber is connected to the outbound fiber.

17. The transponder system of claim 16, further comprising a band reject filter coupled to a trunk fiber, where the band reject filter removes plural wavelengths in the first sub-band.
